(19) United States
(12) Patent Application Publication
(10) Pub. No.: US 2015/0184596 A1
(43) Pub. Date: Jul. 2, 2015

(54) ENGINE-POWERED WORK TOOL PROVIDED WITH WIND GOVERNOR AND MECHANISM FOR INCREASING ENGINE OUTPUT

(71) Applicant: HITACHI KOKI CO., LTD., Tokyo (JP)

(72) Inventors: Tomoya Ikeda, Hitachinaka-shi (JP); Shigetoshi Ishida, Chiba-shi (JP)

(21) Appl. No.: 14/579,653

(22) Filed: Dec. 22, 2014

(30) Foreign Application Priority Data
Dec. 27, 2013 (JP) 2013-272356

(51) Int. Cl. F02D 9/02; F02B 63/02; F01P 5/02

(52) U.S. Cl. CPC F02D 9/02; F01P 5/02; F02B 63/02; F02D 2009/0203; F02D 2009/0208; F02D 2009/021

(57) ABSTRACT

An engine-powered work tool includes an air-cooled engine having a crank shaft, an engine output controller, a wind governor including a governor plate, and a throttle-opening assisting mechanism. The engine output controller includes a throttle valve shaft angularly rotatable about its axis for controlling a rotation speed of the crank shaft based on the angular rotation of the throttle valve shaft. The governor plate is connected to the throttle valve shaft for receiving cooling air generated by a cooling fan connected to the crank shaft. The wind governor controls angular rotation of the throttle valve shaft based on an amount of the received cooling air. The throttle-operation assisting mechanism causes the throttle valve shaft to angularly rotate in a direction to increase the output of the engine within a prescribed rotation speed range, the operation by the throttle-operation assisting mechanism being predominant over the control by the wind governor.

### CROSS REFERENCE TO RELATED APPLICATION

This application claims priority from Japanese Patent Application No. 2013-272356 filed Dec. 27, 2013, the entire content of which is incorporated herein by reference.

### TECHNICAL FIELD

The present invention relates to a work tool provided with a compact engine, such as a brush cutter.

### BACKGROUND

A compact engine is employed as a power source in an electric generator and a portable work tool such as a grass-trimmer, a brush cutter, a blower, a chain-saw, and a power cutter.

Such a conventional engine includes a cooling fan provided on one end of a crank shaft for cooling a cylinder. Rotation of the crank shaft causes the cooling fan to rotate, thereby generating cooling air for cooling the cylinder.

Japanese Patent Application. Publication No. H06-123243 discloses a mechanism in which a wind governor is employed to utilize cooling air for controlling operational states (rotation speed) of an engine. Specifically, a governor plate is disposed on an air flow path of the cooling air within a fan case. The governor plate is connected to a throttle valve shaft of a carburetor that controls a throttle opening in the carburetor. The governor plate is pivotally movable about this throttle valve shaft.

Specifically, in this wind governor, the throttle valve shaft is caused to rotate to decrease the throttle opening when a load decreases, a rotation speed increases, and wind power of cooling air becomes stronger. Conversely, the throttle valve shaft is caused to rotate to increase the throttle opening when the load increases, the rotation speed drops, and wind power of cooling air becomes weaker.

This mechanism is easily configured by simply connecting a small-sized governor plate (wind governor) to the throttle valve shaft and is therefore effective in various types of portable engine-powered work tools that require compact engines.

### SUMMARY

As described above, the output of the engine in a working state can be controlled appropriately by the wind governor. However, control using the wind governor considerably suppresses an output of the engine that can be originally generated by the engine. That is, when the wind governor is employed, the output obtained from the engine is suppressed and becomes considerably smaller than in a case where the wind governor is not employed.

A larger engine output in the working state can still be obtained, even if the wind governor is employed, by improving the structure around the carburetor and the wind governor. In this case, however, because these structures become complicated, an advantage of the wind governor that the above-described control can be performed with a simple structure is impaired. Still further, an actuator or the like can be employed to perform the above-described controls. In this case, too, however, a complicated structure is needed, which is not desirable for a brush cutter and the like that needs to be small and lightweight.

It is thus difficult to improve an engine output in a portable work tool provided with a wind governor, through a simple configuration.

In view of the foregoing, it is an object of the present invention to provide a work tool provided with a wind governor capable of overcoming the above-described drawbacks, with a simple structure.

In order to attain the above and other objects, the invention provides an engine-powered work tool including an air-cooled engine, an engine output controller, a wind governor and a throttle-operation assisting mechanism. The air-cooled engine includes: a crank shaft configured to rotate; and a cooling fan fixed to the crank shaft and configured to rotate together with the crank shaft to generate cooling air. The engine output controller is configured to control an output of the engine, the engine output controller including a throttle valve shaft defining an axis and configured to make an angular rotation about the axis, the output of the engine being controlled based on the angular rotation of the throttle valve shaft. The wind governor is connected to the throttle valve shaft and includes a governor plate configured to move upon receipt of the cooling air thereon, the wind governor being configured to control the angular rotation of the throttle valve shaft based on an amount of the cooling air received by the governor plate. The throttle-operation assisting mechanism is configured to cause the throttle valve shaft to angularly rotate in a direction to increase the output of the engine within a prescribed rotation speed range, the operation by the throttle-operation assisting mechanism being predominant over the control by the wind governor within the prescribed rotation speed range.

Preferably, the throttle-operation assisting mechanism causes the throttle valve shaft to forcibly angularly rotate to increase the output of the engine within the prescribed rotation speed range against the control over the throttle valve shaft by the wind governor.

Preferably, the wind governor is configured to control the throttle valve shaft to angularly rotate to decrease the output of the engine within the prescribed rotation speed range, and the throttle-operation assisting mechanism causes the throttle valve shaft to forcibly angularly rotate to increase the output of the engine within the prescribed rotation speed range against the control over the throttle valve shaft by the wind governor to decrease the output of the engine.

Preferably, the throttle-operation assisting mechanism is configured to be electrically driven to cause angular rotation of the throttle valve shaft upon application of current.

Preferably, the wind governor further includes an arm fixed to the throttle valve shaft, the arm including a magnetic portion configured to be attracted to the throttle-operation assisting mechanism by electromagnetic force, and the throttle-operation assisting mechanism is configured to attract the magnetic portion of the arm to cause the angular rotation of the throttle valve shaft upon application of the current.

Preferably, the wind governor further includes an arm fixed to the throttle valve shaft, the arm including a permanent magnet, and the throttle-operation assisting mechanism is configured to generate a magnetic field to repel the permanent magnet of the arm by repulsive force to cause the angular rotation of the throttle valve shaft upon application of the current.

Preferably, the wind governor further includes an arm fixed to the throttle valve shaft, and the throttle-operation assisting mechanism includes a pin configured to push the arm to cause the angular rotation of the throttle valve shaft upon application of the current.

Preferably, the current applied to the throttle-operation assisting mechanism is generated by the rotation of the crank shaft.

Preferably, the engine-powered work tool further includes a control circuit configured to recognize the rotation speed of the crank shaft and control whether to apply the current to the throttle-operation assisting mechanism based on the rotation speed of the crank shaft.

Preferably, the engine-powered work tool further includes an ignition coil configured to generate spark current for igniting the engine, the control circuit being positioned adjacent to the ignition coil.

Preferably, the engine output controller includes a main body through which the throttle valve shaft penetrates, the throttle valve shaft having one end and another end opposite to each other, the governor plate being fixed to the one end of the throttle valve shaft, and the wind governor further includes a governor spring connected to the another end of the throttle valve shaft to apply a biasing force to the throttle valve shaft in the direction to increase the output of the engine.

Preferably, the wind governor is configured to determine a designated rotation speed of the crank shaft of the engine operating under no load, and the prescribed rotation speed range is set to be equal to or lower than the designated rotation speed.

Preferably, the engine-powered work tool further includes: an end tool configured to be driven in accordance with the rotation of the crank shaft; and a supporting shaft having one end provided with the end tool and another end provided with the air-cooled engine, the engine output controller, the wind governor and the throttle-operation assisting mechanism.

### BRIEF DESCRIPTION OF THE DRAWINGS

In the drawings:

FIG. 1A is a side view showing a general construction of a brush cutter according to an embodiment of the present invention;

FIG. 1B is an enlarged cross-sectional view of a drive section of the brush cutter of the embodiment enclosed by a broken line in FIG. 1A;

FIG. 2 is a front view of the drive section, without a fan case, of the brush cutter according to the embodiment, wherein the drive section includes an engine and a wind governor;

FIG. 3 is a side view showing a configuration near a distal end of a handle of the brush cutter according to the embodiment;

FIG. 4 is a rear view of the drive section of the brush cutter according to the embodiment;

FIGS. 5A and 5B are views explaining switching operations between an idling state and a working state in the brush cutter of the embodiment as viewed from the rear side thereof;

FIGS. 6A to 6C are views illustrating operations of the wind governor in the brush cutter of the embodiment as viewed from the front side thereof;

FIGS. 7A-7C are views explaining operations of a throttle-operation assisting coil as an example of a throttle-operation assisting mechanism of the present invention;

FIG. 8A is a graph illustrating a relationship between a rotation speed of the engine and timings for applying current to the throttle-operation assisting coil;

FIG. 8B is a graph illustrating a relationship between the rotation speed of the engine and current flowing through the throttle-operation assisting coil;

FIG. 9 is a graph comparing output characteristics of the engine of the embodiment with output characteristics of conventional engines, wherein a curve (1) represents output characteristics of a conventional engine without a wind governor, a curve (2) represents output characteristics of a conventional engine provided only with a wind governor, and a curve (3) represents output characteristics of the engine of the embodiment; and

FIGS. 10A-10C are views explaining operations of an actuator as another example of the throttle-operation assisting mechanism of the embodiment.

### DETAILED DESCRIPTION

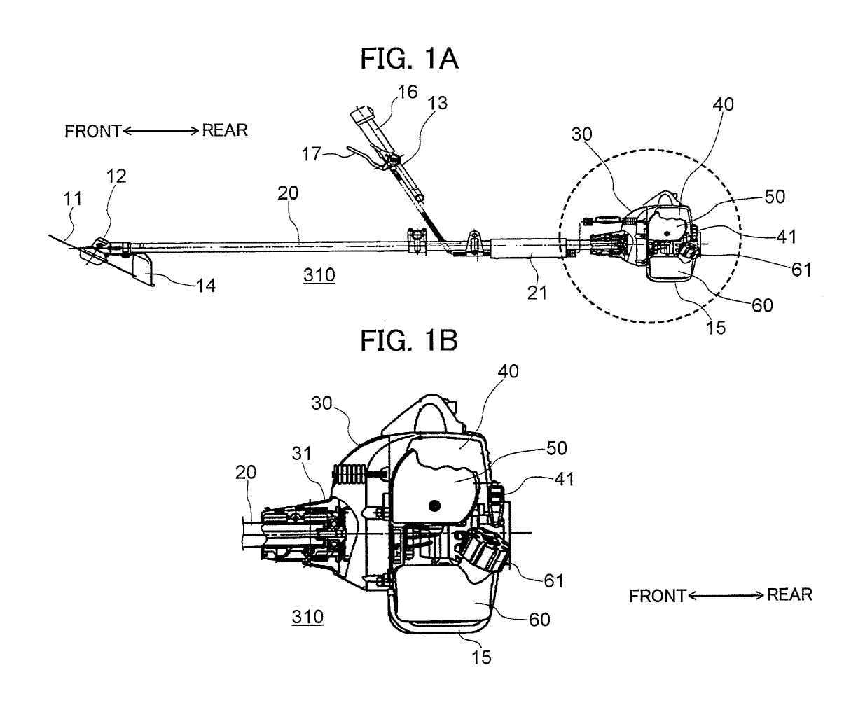

A brush cutter 310 as an example of an engine-powered work tool according to an embodiment of the present invention will be described with reference to FIGS. 1A through 10C.

Descriptions used in the following description in relation to the brush cutter 310 will reference the state of the brush cutter 310 shown in FIG. 1A assuming that the brush cutter 310 is placed on the ground. Specifically, hereinafter, left and right sides of the brush cutter 310 shown in FIG. 1A will be referred to as the “front side” and “rear side” respectively and an up-down direction in FIG. 1A will be referred to as an up-down direction or a vertical direction.

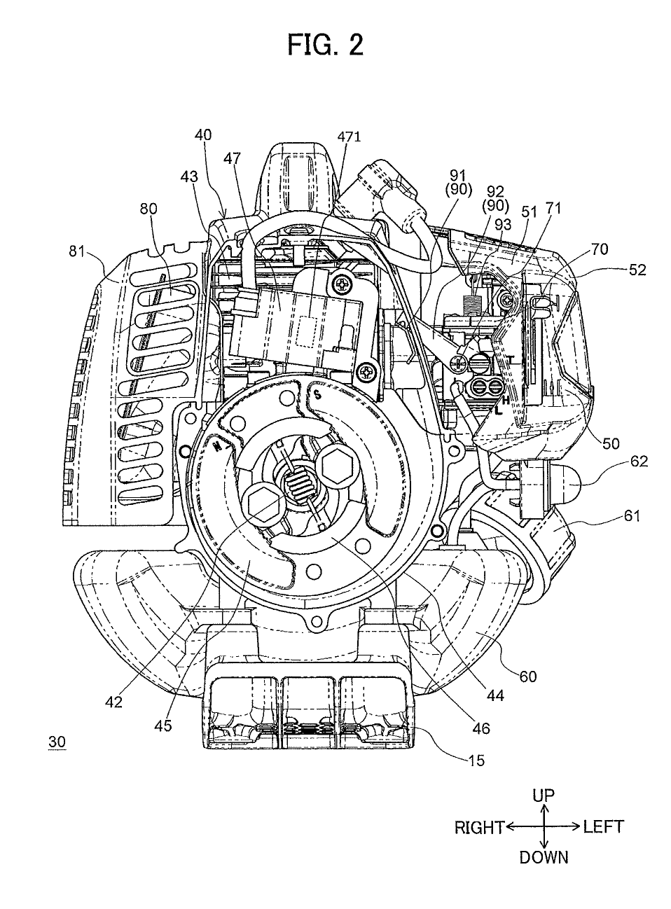

Referring to FIGS. 1A and 1B, the brush cutter 310 includes a shaft 20 extending in a front-rear direction, a cutting blade 11, and a drive section 30 that accommodates an engine 40. The cutting blade 11 is rotatably provided on a front end portion (one end) of the shaft 20 as an example of an end tool. The drive section 30 is disposed at a rear end portion (another end) of the shaft 20 for driving (rotating) the cutting blade 11. The engine 40 is used as a power source of the drive section 30. A drive shaft (not shown) is coaxially disposed within the shaft 20 and is connected to a crank shaft 42 (see FIG. 2) of the engine 40 through a centrifugal clutch 46 (see FIG. 2). When a rotation speed of the crank shaft 42 (rotation speed of the engine 40) increases and the centrifugal clutch 46 is connected to the drive shaft, the drive shaft (not shown) starts to rotate upon receipt of the drive power from the engine 40. This rotation of the drive shaft is transmitted to a gear case 12 provided at the front end portion of the shaft 20 to rotate the cutting blade 11 at an appropriate speed reduction ratio.

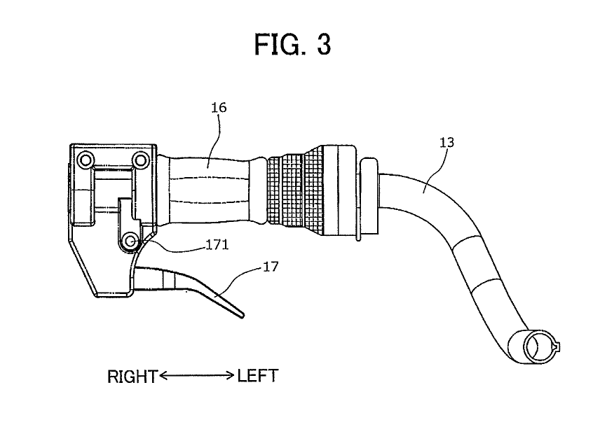

Handles 13 for gripping by an operator are provided at respective left and right sides near a center portion of the shaft 20 in the front-rear direction. In FIG. 1A, only one of the handles 13 (right handle 13) is shown. A grip 16 is provided on a distal end portion of each of the handles 13. Referring to FIG. 3, on the right handle 13, a throttle lever 17 is also provided for realizing switching the rotation speed of the engine 40 between an idling state and a working state, as will be described later. The throttle lever 17 is pivotally movable about a throttle lever pivot 171 provided near the distal end side of the grip 16.

Further, a waist pad portion 21 is provided on the shaft 20 between the handles 13 and drive section 30 for facilitating operator's operations while holding the handles 13. Specifically, the waist pad portion 21 is formed by an elastic material provided on the shaft 20 to cover (surround) the same such that the waist pad portion 21 has an outer diameter larger than that of the shaft 20. The operator performs cutting work while gripping the handles 13 (grips 16) with his or her waist supported by the waist pad portion 21. Still further, an antiscattering cover 14 is provided below the cutting blade 11 for preventing cut grass and braches from being scattered toward the operator.

The drive section 30 includes the engine 40, a fuel tank 60, a protective cover 15, a carburetor 70, an air cleaner 50, a muffler 80 and a wind governor 90. The fuel tank 60 is fixedly provided below the engine 40 for storing fuel. Before using the brush cutter 310, the operator should remove a tank cap 61 (see FIGS. 1A, 1B and 2) for supplying fuel into the fuel tank 60. In general, a fuel tank and its tank cap are provided below an engine in order to prevent supplied fuel from adhering to an ignition plug provided at the engine or wirings connected to the ignition plug. The fuel tank 60 is thus positioned at a lower rear end portion of the brush cutter 310 (lower portion of the drive section 30).

As illustrated in FIGS. 1A and 1B, the protective cover (stand) 15 is provided to cover a lower portion of the fuel tank 60. The protective cover 15 is made of a resin material and is designed to support the brush cutter 310 when the brush cutter 310 is placed on the ground.

Referring to FIG. 2, the engine 40 is a compact two-cycle air-cooled engine and includes a cylinder 43, the crank shaft 42 and a cooling fan (not shown). The cylinder 43 is provided in an upper portion of the engine 40. The cylinder 43 mainly includes a combustion chamber and a piston (not shown). The cylinder 43 has an outer peripheral surface in which a large number of cooling fins are formed. The cooling fan (not shown) is fixed to a front end portion of the crank shaft 42. A suction port (not shown) is provided to the left of the cylinder 43 and an exhaust port (not shown) is provided to the right of the cylinder 43.

The carburetor 70 (an example of an engine output controller) is attached to the suction port provided on the left side (on the right side in FIG. 2) of the cylinder 43. The air cleaner 50 is attached to a left end portion of the carburetor 70. More specifically, the air cleaner 50 is covered with an air cleaner cover 52 and is attached to an air cleaner box 51 fixed to the carburetor 70. With this structure, air is introduced into the carburetor 70 through the air cleaner 50. Fuel is also supplied to the carburetor 70 from the fuel tank 60 via a tube. The carburetor 70 is configured to generate air-fuel mixture therein and supply the same to the engine 40.

The muffler 80 is attached to the exhaust port provided to the right (on the left side in FIG. 2) of the cylinder 43. Through the muffler 80, air from the engine 40 (cylinder 43) is exhausted. The muffler 80 tends to be hot in temperature when used and is therefore covered by a muffler cover 81.

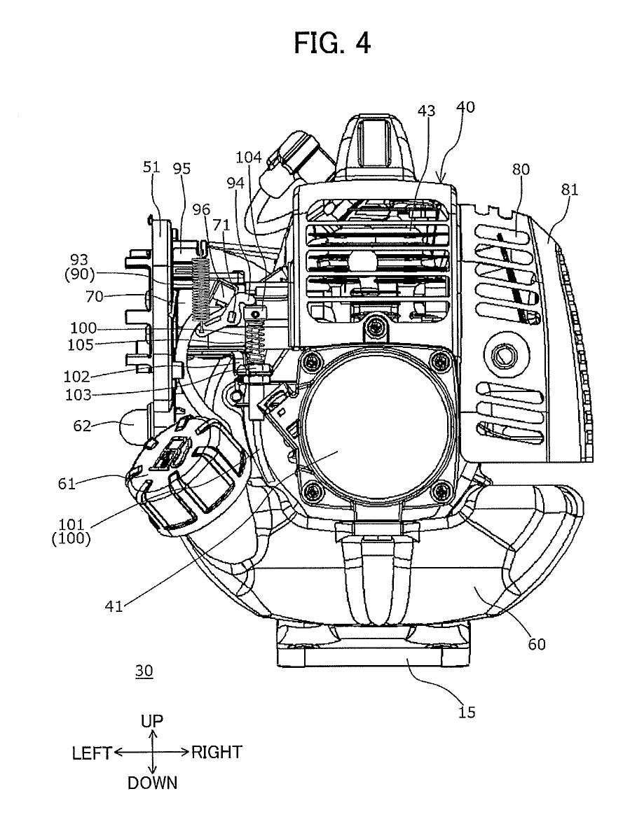

In the engine 40, a crank case 44 is provided below the cylinder 43. The crank case 44 includes the crank shaft 42 thereinside. The crank shaft 42 is configured to rotate in association with a vertical reciprocating movement of the piston within the cylinder 43. The crank shaft 42 extends in the front-rear direction in FIG. 1A (in a direction perpendicular to the sheet surface of FIG. 2). On the front end portion if the crank shaft 42, a magnet rotor 45 and the centrifugal clutch 46 are provided. The magnet rotor 45 is integral with the cooling fan (not shown) for generating cooling air for cooling the cylinder 43. The generated cooling air is configured to flow through a fan case 31 covering the cooling fan (see FIG. 1B) and form an air flow path for cooling the cylinder 43 which becomes particularly hot among other components in the engine 40. On the other hand, a starter (recoil starter) 41 is attached to a rear end portion of the crank shaft 42 to forcibly rotate the crank shaft 42 for staring the engine 40 (see FIGS. 1A, 1B and 4). With this structure, current flows through a generator coil (not illustrated) as the magnet rotor 45 rotates, and the current flows into an ignition coil 47 (ignition system), is accumulated therein up to a level high enough to ignite the ignition plug (not shown) and is then supplied to the ignition plug as a spark current.

Further, referring to FIG. 2, a control circuit 471 including a CPU is provided adjacent to the ignition coil 47. The control circuit 471 rectifies a part of the current generated in the generator coil to generate a DC current, supplies the DC current to a throttle-operation assisting coil 96 (see FIG. 4), thereby controlling ON and OFF of the throttle-operation assisting coil 96, as will be described later. Further, the control circuit 471 is configured to recognize the rotation speed (the number of rotations) of the crank shaft 42, by monitoring output of the generator coil and the ignition coil 47 (ignition system). As will be described later, the current supplied to the throttle-operation assisting coil 96 is controlled based on this rotation speed of the crankshaft 42. The throttle-operation assisting coil 96 is an example of a throttle-operation assisting mechanism of the present invention, which functions in conjunction with operations of the control circuit 471 as an example of a control circuit of the present invention.

Once the engine 40 has started, the fuel is introduced (sucked) from the fuel tank 60 up to the carburetor 70 by a negative pressure generated at the time of air intake. However, before the engine 40 is started, the fuel needs to be manually taken up to the carburetor 70. To this end, a priming pump 62 is provided as shown in FIGS. 2 and 4. As the operator operates the priming pump 62, the fuel is pumped up from the fuel tank 60 to the carburetor 70 before the engine 40 is started.

While the fuel (mixed gasoline) is supplied from the fuel tank 60 to the carburetor 70, air is also introduced into the carburetor 70 through the air cleaner 50. An air-fuel mixture is generated in the carburetor 70 and is supplied to the engine 40.

A combination of an engine and a carburetor having similar configurations as the engine 40 and carburetor 70 can be used not only for an engine-powered work tool such as the brush cutter 310 of the present embodiment, but also be applicable to other machines, such as a motorbike. However, in case of a motorbike, an angle formed between its carburetor and the ground (horizontal plane) does not vary significantly while the motorbike is in operation (during driving). In contrast, in case of the brush cutter 310, an angle formed between the shaft 20 and the ground (horizontal plane) is often likely to change while the brush cutter 310 is being used. For example, the operator may hold the shaft 20 horizontally generally parallel to the ground, or may turn the shaft 20 into an orientation significantly inclined relative to the horizontal plane in order to adjust a cutting angle.

Although there are various types of carburetors, a diaphragm-type carburetor is effective for stably supplying fuel and generating air-fuel mixture even when the angle between the carburetor and the horizontal plane varies significantly. In the diaphragm-type carburetor, a fuel chamber formed within the carburetor is partitioned by a diaphragm formed of an elastic body, and fuel is sucked up into this fuel chamber and stored therein by a certain amount. This configuration allows stable supply of the air-fuel mixture irrespective of the angle of the carburetor relative to the horizontal plane. For this reason, the diaphragm-type carburetor is preferable as the carburetor 70 of the present embodiment.

The carburetor 70 is also a so-called butterfly-type carburetor and includes a throttle valve shaft 71 and a butterfly valve (not shown). The throttle valve shaft 71 is configured to angularly rotate about its axis extending in the front-rear direction in response to operations of the wind governor 90, as will be described later. The butterfly valve is configured to pivotally move within and relative to the throttle valve shaft 71 in accordance with the angular rotation of the throttle valve shaft 71. By how much the throttle valve shaft 71 angularly rotates and by how much the butterfly valve pivotally moves relative to the throttle valve shaft 71 in response to the angular rotation of the throttle valve shaft 71 determines a throttle opening of the throttle valve shaft 71 (or the carburetor 70). In the carburetor 70 of this structure, the throttle opening can be adjusted in accordance with the angular rotation of the throttle valve shaft 71. Generally speaking, such a butterfly-type carburetor is preferable as a carburetor for an engine-powered work tool. In other words, a diaphragm-type carburetor provided with a throttle opening adjusting mechanism using a butterfly valve is particularly preferable to be used in an engine-powered work tool, just as the carburetor 70 of the present embodiment.

The rotation speed (the number of rotations) of the engine 40 (output of the engine 40) is controlled based on an amount of the air-fuel mixture supplied from the carburetor 70. A rotating state of the engine 40 can be roughly divided into two: an idling state and a working state. In the idling state, the rotation speed of the engine 40 is maintained low and the centrifugal clutch 46 is not connected to the drive shaft to prevent the cutting blade 11 from rotating. In the working state, the rotation speed of the engine 40 is maintained higher than that in the idling state, and the centrifugal clutch 46 is connected to the drive shaft to permit the cutting blade 11 to rotate.

In order to realize switching between the idling state and working state, the operator pulls (grips) the throttle lever 17 provided near the right grip 16 (shown in FIG. 3). The throttle lever 17 is connected to a throttle wire 100 (FIG. 4) that is connected to the carburetor 70. That is, throttle wire 100 has one end connected to the throttle lever 17, and another end connected to the carburetor 70. When the operator grips the throttle lever 17 to pivotally move a right end portion thereof upward in FIG. 3 about the throttle lever pivot 171, the throttle wire 100 can be pulled toward the handle 13 side, by which the carburetor 70 is brought into its working state, as will be described later. A switching operation between the idling state and the working state can be thus performed by movement of the one end of the throttle wire 100 at the drive section 30 side.

The throttle wire 100 is slidably movably provided inside an outer tube 101, as shown in FIG. 4. The outer tube 101 is fixed, by a mounting nut 103, to a throttle wire mounting portion 102 fixed to the carburetor 70. The end (end portion) of the throttle wire 100 (opposite to the end connected to the throttle lever 17) is exposed from the outer tube 101 above the throttle wire mounting portion 102. The end portion of the throttle wire 100 exposed from the outer tube 101 has an upper end to which an arm abutting portion 104 is attached. The arm abutting portion 104 is configured to abut on a right end portion of an arm 94 of the wind governor 90 from below, as will be described later. Further, a throttle return spring 105 is disposed between the arm abutting portion 104 and throttle wire mounting portion 102 such that the throttle wire 100 exposed from the outer tube 101 is wound around by the throttle return spring 105. The arm abutting portion 104 and throttle wire 100 connected thereto are thus normally biased upward due to expansion (biasing force) of the throttle return spring 105, thereby biasing the arm abutting portion 104 toward the arm 94.

Cutting work is performed only in the working state. In the working state, first, in a no-load-applied condition, the rotation speed of the engine 40 is set to a prescribed rotation speed. Then, when the operator puts the rotating cutting blade 11 in contact with grass and branches, a large load is applied to the cutting blade 11, and hence it becomes necessary to increase the throttle opening and to increase the engine output. After that, when the operator separates the cutting blade 11 from grass and branches in order to finish the cutting work, the load applied to the cutting blade 11 decreases rapidly. In this state, if the throttle opening has been increased, the rotation speed may possibly increase rapidly. Hence, when no load is applied, the throttle opening needs to be decreased.

For controlling the throttle opening (angular rotation of the throttle valve shaft 71), the wind governor 90 is provided on the throttle valve shaft 71 of the carburetor 70, referring to FIGS. 2 and 4. The wind governor 90 utilizes the cooling air generated by the cooling fan to control the rotation speed of the engine 40 in the working state. The wind governor 90 is arranged to be on the air flow path of the cooling air so as to receive the cooling air within the fan case 31. The wind governor 90 is thus subject to the strength of the cooling air applied thereto.

Specifically, the wind governor 90 includes a governor plate 91, a governor rod 92, a governor spring 93 and the arm 94.

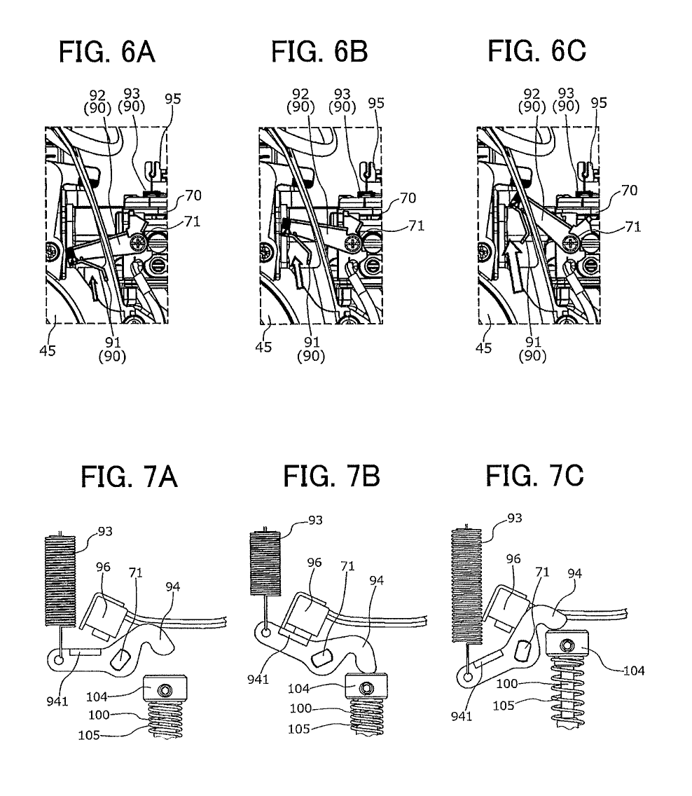

The governor plate 91 is configured to receive the cooling air. As shown in FIGS. 2 and 6A to 6C, the governor plate 91 is provided on a distal end of the governor rod 92. The governor rod 92 has a generally rectangular shape elongated in the left-right direction in a front view. The governor rod 92 has a base end connected to a front end portion of the throttle valve shaft 71. The governor plate 91 is thus mechanically linked to the throttle valve shaft 71 via the governor rod 92. Upon receipt of the cooling air at the governor plate 91, the governor rod 92 is configured to apply a force to the throttle valve shaft 71 to cause the throttle valve shaft 71 to angularly rotate clockwise or counterclockwise in FIGS. 2 and 6A to 6C.

Further, as shown in FIG. 4, the arm 94 is fixed to a rear end portion of the throttle valve shaft 71 (i.e., the arm 94 is positioned on an end of the throttle valve shaft 71 opposite to the end on which the governor plate 91 is provided). Note that in FIG. 4, the air cleaner 50 and air cleaner cover 52 are removed. The arm 94 has a left end portion engaged with a lower end of the governor spring 93. The governor spring 93 has an upper end that is positioned higher than the arm 94 and is engaged with a governor spring mounting portion 95 provided on the air cleaner box 51 fixed to the carburetor 70. With this structure, the arm 94 (left end portion thereof) is normally pulled (biased) upward in FIG. 4 by a biasing force of the governor spring 93. The governor spring 93 is configured to bias the throttle valve shaft 71 in a direction to increase the throttle opening (to increase the rotation speed or output of the engine 40), i.e., clockwise in FIG. 4 (counterclockwise in FIG. 2).

Further, the throttle-operation assisting coil 96 is provided at the left side of the governor spring 93 (right side in FIG. 4) as the throttle-operation assisting mechanism. The throttle-operation assisting coil 96 is fixed to the carburetor 70, and can attract an arm attracted portion 941 provided on the arm 94 by magnetic force (see FIGS. 7A-7C) upon application of current. The arm attracted portion 941 (an example of a magnetic portion) is provided on the left end portion of the arm 94 and is made from ferromagnetic body. The direction of this attraction is identical to the direction in which the governor spring 93 urges the arm 94. The operations of the throttle-operation assisting coil 96 will be described later.

That is, in FIG. 4, the left end portion of the arm 94 (throttle valve shaft 71) is biased clockwise basically by the governor spring 93, while the right end portion of the arm 94 is biased counterclockwise by the throttle return spring 105 through the arm abutting portion 104. That is, the left and right end portions of the arm 94 are biased respectively in two opposite directions.

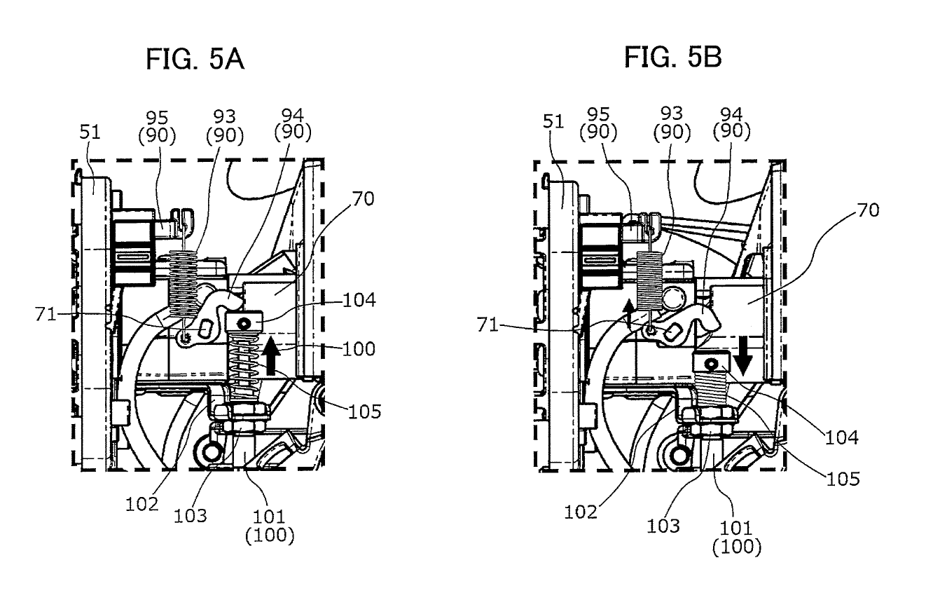

It should be noted here that, by simple comparison between the governor spring 93 and throttle return spring 105, the torque applied to the arm 94 from the throttle return spring 105 is set to be larger than the torque applied to the arm 94 from the governor spring 93. Hence, as long as the throttle return spring 105 expands, the arm abutting portion 104 abuts on the right end portion of the arm 94 from below irrespective of the state of the governor spring 93. The throttle valve shaft 71 is thus biased in the counterclockwise direction in FIG. 4 (clockwise direction in FIG. 2). In other words, while the throttle wire 100 is not operated and thus the throttle return spring 105 is not contracted downward, the throttle opening is rendered small (reduced). This is the idling state (shown in FIGS. 4 and 5A). In the idling state, the centrifugal clutch 46 is not connected, and the cutting blade 11 is not driven.

Note that the shape of the arm 94 shown in FIGS. 5A and 5B is different from that shown in FIGS. 4 and 7A-7C, but the arm 94 in FIGS. 5A and 5B is assumed to the same as the arm 94 shown in FIGS. 4 and 7A-7C.

When the operator grips the throttle lever 17, the throttle wire 100 is pulled downward in FIG. 4 against the biasing force of the throttle return spring 105. This is the working state shown in FIG. 5B. At this time, since the arm abutting portion 104 is separated from the arm 94, the arm 94 is caused to pivotally move (throttle valve shaft 71 rotates) in the clockwise direction by the governor spring 93. As a result, the rotation speed of the engine 40 increases, the centrifugal clutch 46 is connected to rotate the cutting blade 11.

At this time, in the working state, the wind governor 90 is used to perform control as described below with reference to FIGS. 6A to 6C.

In FIGS. 6A to 6C, the flow (strength) of the cooling air is indicated by a white arrow. FIG. 6A illustrates a state where the rotation speed of the engine 40 is low (strength of the cooling air is low), FIG. 6C illustrates a state where the rotation speed of the engine 40 is high (strength of the cooling air is high), and FIG. 6B illustrates an intermediate state between FIGS. 6A and 6C.

Here, in the wind governor 90, when the cooling air applied to the governor plate 91 increases (a larger pressure is applied to the governor plate 91 from the cooling air), the throttle valve shaft 71 is caused to angularly rotate in a direction to reduce the throttle opening (i.e., clockwise direction in FIGS. 6A-6C) to reduce the rotation speed of the engine 40. Note that, at this time, the arm 94 provided on the other end of the throttle valve shaft 71 is biased by the governor spring 93 in the direction to increase the throttle opening.

Specifically, when the rotation speed of the engine 40 decreases and the strength of the cooling air is reduced as shown in FIG. 6A in response to application of a load to the cutting blade 11, the governor spring 93 causes the throttle valve shaft 71 to angularly rotate in the direction to increase the throttle opening, i.e., clockwise in FIG. 4. In contrast, when the rotation speed of the engine 40 increases and the strength of the cooling air is increased as shown in FIG. 6C in response to cancellation of the load applied on the cutting blade 11, the governor spring 93 causes the throttle valve shaft 71 to angularly rotate in the direction to reduce the throttle opening, i.e., counterclockwise in FIG. 4. Thus, the rotation speed of the engine 40 (output of the engine 40) is controlled appropriately. Further, through these operations, the rotation speed of the engine 40 is controlled substantially constant when no load is applied to the cutting blade 11. This rotation speed of the engine 40 defined by the wind governor 90 under no load is a designated rotation speed of the engine 40.

The designated rotation speed is determined by adjusting relationships among the wind governor 90 (the governor plate 91, a spring constant of the governor spring 93, etc.), the throttle valve shaft 71, and the like. For example, the designated rotation speed can be increased when tension (spring constant) of the governor spring 93 is increased, while the designated rotation speed can be decreased when this tension is reduced. Alternatively, for example, by changing an attachment position of the governor spring 93, too, the designated rotation speed or the engine output corresponding to the designated rotation speed can be made variable. These are possible example of designated rotation speed changing means that may be provided in the brush cutter 310 of the present embodiment.

Generally, in case of an engine without a wind governor, output of the engine would be likely to become larger as the rotation speed is higher. Hence, by increasing the designated rotation speed, a larger output can be obtained from the engine in the working state. However, if the designated rotation speed is increased, fuel consumption will increase even when cutting work is not actually performed in the working state. Thus, increasing the designated rotation speed is not preferable to obtain a larger output. Rather, it is desirable to obtain a larger engine output at a low rotation speed, without increasing the designated rotation speed.

To this end, in the brush cutter 310 of the present embodiment, in addition to the above-described control based on the movement of the wind governor 90 to cause angular rotation of the throttle valve shaft 71 to decrease or increase the output of the engine 40, a control using the throttle-operation assisting coil 96 is performed.

Now the control performed by the throttle-operation assisting coil 96 is described with reference to FIGS. 7A-7C. In FIGS. 7A-7C, for simplifying explanation, only parts relating to the operations of the throttle operation assisting coil 96 are shown schematically.

FIGS. 7A and 7B represent the working state of the engine 40, since the throttle wire 100 is pulled downward. Here, FIG. 7A is a state where there is no load applied on the cutting blade 11. In this state, the force of the governor spring 93 that pulls up the arm 94 (force to increase the throttle opening) balances the force of cooling air that pushes up the governor plate 91 (force to decrease the throttle opening). The rotation speed of the engine 40 corresponding to this state is the designated rotation speed.

If a load is added to the cutting blade 11 in the state shown in FIG. 7A, the rotation speed of the engine 40 drops and the strength of cooling air is reduced. As a result, the force of cooling air that pushes up the governor plate 91 (force to decrease the throttle opening) decreases. Hence, as shown in FIG. 7B, the governor spring 93 causes the throttle valve shaft 71 to pivot in the direction to increase the throttle opening (clockwise in FIGS. 7A-7C). At this time, current is applied to the throttle-operation assisting coil 96 so that the arm attracted portion 941 (the arm 94) can be pulled up by the magnetic force of the throttle-operation assisting coil 96, in addition to the biasing force of the governor spring 93. In the embodiment, this energization of the throttle-operation assisting coil 96 is so configured to be performed in a prescribed rotation speed range (from 5500 rpm to 7000 rpm). Hence, in the engine 40 of the present embodiment, although the wind governor 90 is employed, the wind governor 90 does not function practically in the prescribed rotation speed range. Further, when the rotation speed of the engine 40 is lower than the prescribed rotation speed range, the wind governor 90 does not function practically either, since wind power is too weak to activate the wind governor 90. That is, the wind governor 90 practically functions only at rotation speeds higher than this prescribed rotation speed range.

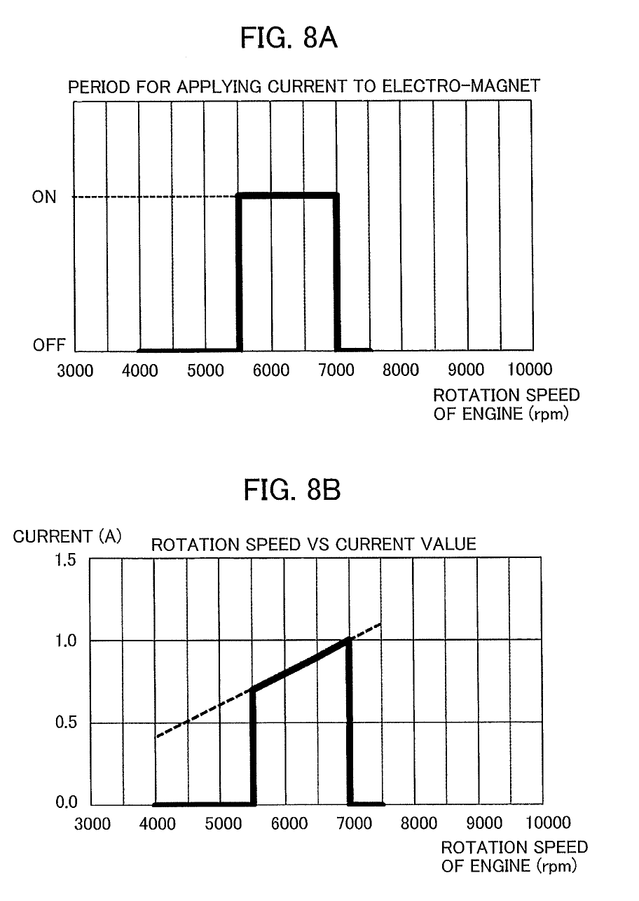

Whether to apply current to the throttle-operation assisting coil 96 is configured to be controlled by the control circuit 471. FIG. 8A shows an example of the prescribed rotation speed range in which the throttle-operation assisting coil 96 is applied with current (i.e., the throttle-operation assisting coil 96 is turned ON). In this example, the designated rotation speed of the engine 40 under no load in the working state is 7000 rpm. The attraction force by the throttle-operation assisting coil 96 is so set to be exerted in the prescribed rotation speed range of from 5500 rpm to 7000 rpm. Further, the rotation speed in the idling state is set to be lower than or equal to 4000 rpm.

As current flowing into the throttle-operation assisting coil 96 used is a part of the current that is generated in the generator coil (not shown) by the rotation of the magnet rotor 45 and supplied to the ignition coil (ignition system) 47. Thus, the current applied to the throttle-operation assisting coil 96 is proportional to the rotation speed in the prescribed rotation speed range (while the throttle-operation assisting coil 96 is rendered ON). FIG. 8B shows a relationship between the rotation speed and the current flowing through the throttle-operation assisting coil 96.

In this example, if the rotation speed of the engine 40 is lower than 7000 rpm in the working state, the throttle-operation assisting coil 96 is energized upon application of current to control the engine output to increase. Here, if the load applied on the cutting blade 11 decreases and the rotation speed increases rapidly to exceed 7000 rpm, for example, application of current to the throttle-operation assisting coil 96 is stopped to cancel the attraction by the throttle-operation assisting coil 96 (i.e., attraction force by the throttle-operation assisting coil 96 becomes zero). Accordingly, the throttle opening is controlled to decrease by the sole function of the wind governor 90, and the output of the engine 40 is thus reduced.

At rotation speeds lower than or equal to 7000 rpm, too, wind pressure received by the governor plate 91 increases as the rotation speed increases. Thus, the operation of the wind governor 90 to urge the throttle valve shaft 71 in the direction to close the throttle opening in accordance with increase in the rotation speed is indeed performed substantially in the same manner as in a case where the rotation speed exceeds 7000 rpm. As the rotation speed becomes closer to 7000 rpm, this urging force of the wind governor 90 becomes especially larger. On the other hand, as shown in FIG. 8B, at rotation speeds lower than or equal to 7000 rpm, where the current flowing through the throttle-operation assisting coil 96 is proportional to the rotation speed as described above, the attraction force of the throttle-operation assisting coil 96 becomes stronger as the rotation speed increases. In other words, this attraction force by the throttle-operation assisting coil 96 becomes larger in response to torque that is generated upon receipt of cooling air at the governor plate 91. Hence, in the prescribed rotation speed range of between 5500 and 7000 rpm, the state shown in FIG. 7B is constantly maintained where the arm 94 is attracted by the throttle-operation assisting coil 96 to be engaged with the same.

That is, in this configuration, the wind governor 90 substantially functions only for the operation to reduce the engine output or the rotation speed at the rotation speeds over 7000 rpm. When the rotation speed is higher than or equal to 5500 rpm and lower than or equal to 7000 rpm, only the throttle-operation assisting coil 96 functions practically to obtain a maximum throttle opening of the throttle valve shaft 71.

As in a conventional art, when the rotation speed of the engine 40 exceeds the designated rotation speed, the wind governor 90 operates appropriately to reduce the output of the engine 40.

Further, as described above, the rotation speed in the idling state is set to 4000 rpm in the embodiment, which is sufficiently lower than 5500 rpm. Thus, the attraction force by the throttle-operation assisting coil 96 is not generated in the idling state. Further, the torque exerted on the arm 94 by the throttle return spring 105 is set to be larger than the torque exerted on the arm 94 by the attraction force of the throttle-operation assisting coil 96. Thus, when the operator releases the throttle lever 17, the throttle valve shaft 71 is caused to be pivotally moved forcefully by the throttle return spring 105 so as to minimize the throttle opening even if the throttle-operation assisting coil 96 is turned ON in the working state. As a result, the engine 40 is brought into the idling state as shown in FIG. 7C. That is, just as if the throttle-operation assisting coil 96 was not employed, switching between the idling state and the working state is performed as shown in FIGS. 5A and 5B.

Incidentally, a detection switch may be provided at the throttle lever 17 so that current cannot be applied to the control circuit 471 unless the throttle lever 17 is gripped. This configuration can realize more reliable switching to the idling state, and suppress accidental flowing of current into the throttle-operation assisting coil 96.

As described above, in the brush cutter 310 of the present embodiment, the wind governor 90 can function to check occurrence of over speed under no load condition, while, in the prescribed rotation speed range in which the throttle-operation assisting coil 96 is rendered ON, the output of the engine 40 is not curbed but can be made substantially equivalent to the output of the engine without the wind governor.

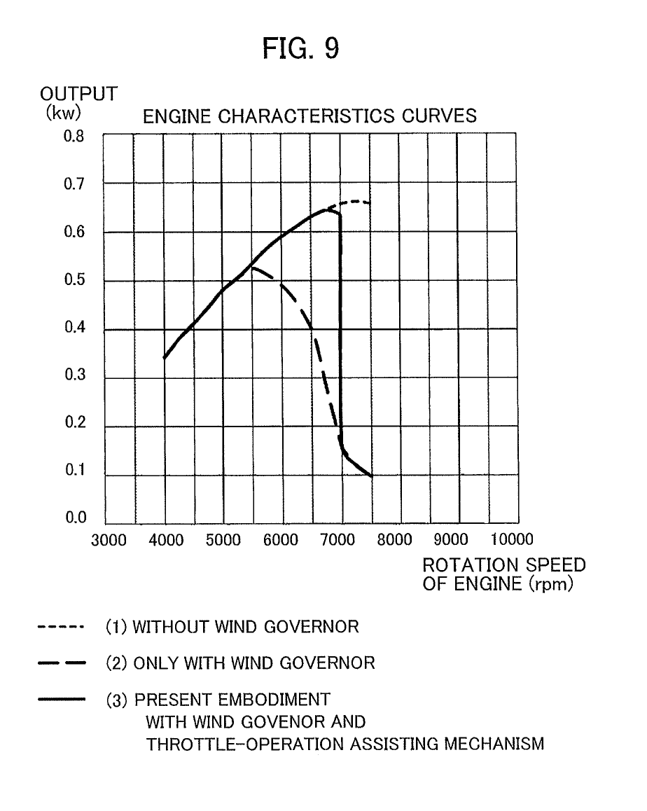

FIG. 9 schematically shows engine output characteristics of the present embodiment compared with those of conventional structures. Specifically, in FIG. 9, a curve (1) shows output characteristics of an engine under no load in which neither a wind governor mechanism nor throttle-operation assisting mechanism is employed. A curve (2) shows output characteristics of an engine under no load in which a wind governor mechanism is provided but throttle-operation assisting mechanism is not employed. A curve (3) shows output characteristics of the engine 40 of the present embodiment under no load in which a wind governor mechanism (wind governor 90) and throttle-operation assisting mechanism (throttle-operation assisting coil 96) are both employed in combination.

In the case (1) where no wind governor mechanism is employed, original output characteristics of the engine are exhibited. Thus, the largest output is obtained at all rotation speeds, and a large output is obtained even when the rotation speed exceeds 7000 rpm which is the designated rotation speed. This means that suitable output control (rotation speed control) is not performed at all in a brush cutter provided with this engine with no wind governor mechanism. In the case (2) where only the wind governor mechanism is employed, the output decreases when the rotational speed exceeds 7000 rpm, since the wind governor mechanism functions to control (suppress) output of the engine. Also, the output in the prescribed rotation speed range of between 5500 and 7000 rpm is made considerably lower than that of the case (1) where no governor mechanism is employed. This is because the wind governor mechanism functions not only in the rotation speed range higher than or equal to 7000 rpm, but also functions when the rotation speed is lower than or equal to 7000 rpm. Further, due to weak wind power, in a low rotation speed range in which the wind governor mechanism does not function practically (lower than or equal to 5500 rpm), there is no difference in output between the case (2) where only the wind governor is employed and the case (1) where no wind governor is employed. It should be noted here that, because the rotation speed is low, the absolute output of the engine is small in either case.

In contrast, in the case (3) where the throttle-operation assisting mechanism (throttle-operation assisting coil 96) is employed, the wind governor mechanism (wind governor 90) functions practically only in the rotation speed range over 7000 rpm. Hence, although the output of the engine 40 decreases rapidly over 7000 rpm, the output in the prescribed rotation speed range of between 5500 and 7000 rpm can be made almost identical to that of the case (1) where no wind governor mechanism is employed. That is, the wind governor 90 is used to appropriately control (suppress) the output when the rotation speed exceeds 7000 rpm, whereas a larger output can be obtained in the prescribed rotation speed range of between 5500 and 7000 rpm, which is used in the working state, than that in the case (2). Thus, the output of the engine 40 in the working state can be enhanced efficiently to perform cutting work.

Further, in the case (2), change in the output characteristics is gentle or gradual in a higher rotation speed range. Hence, the designated rotation speed (7000 rpm in the above example) needs to be increased in order to obtain a larger output from the engine 40. In contrast, in the case (3) of the present embodiment where the throttle-operation assisting mechanism (throttle-operation assisting coil 96) is used in combination with the wind governor 90, the same output can be obtained at a lower designated rotation speed than in the case (2). Thus, for example, fuel consumption in the working state (cutting work) can be held low.

As described above, what is significant in the configuration of the brush cutter 310 of the present embodiment is that, regardless of the throttle opening of the carburetor 70 controlled by the wind governor 90, in the working state, when the rotation speed of the engine 40 is within the prescribed range (lower than or equal to the designated rotation speed), the throttle-operation assisting coil 96 functions to forcibly increase the throttle opening although the wind governor 90 controls to decrease the throttle opening. That is, within this prescribed rotation speed range, the wind governor 90 is controlled not to function practically. Put another way, the operation by the throttle-operation assisting coil 96 (throttle-operation assisting mechanism) is predominant over the control by the wind governor 90 within the prescribed rotation speed range. With this structure, a larger output of the engine 40 can be obtained without increasing the designated rotation speed.

Various modifications and variations are conceivable.

In the above-described embodiment, the throttle-operation assisting coil 96 for attracting the arm 94 is employed as the throttle-operation assisting mechanism. However, a structure other than the position-sensor sensed portion 96 may be employed as the throttle-operation assisting mechanism, provided that movement of the arm 94 can be electrically manipulated in a similar manner as in the depicted embodiment.

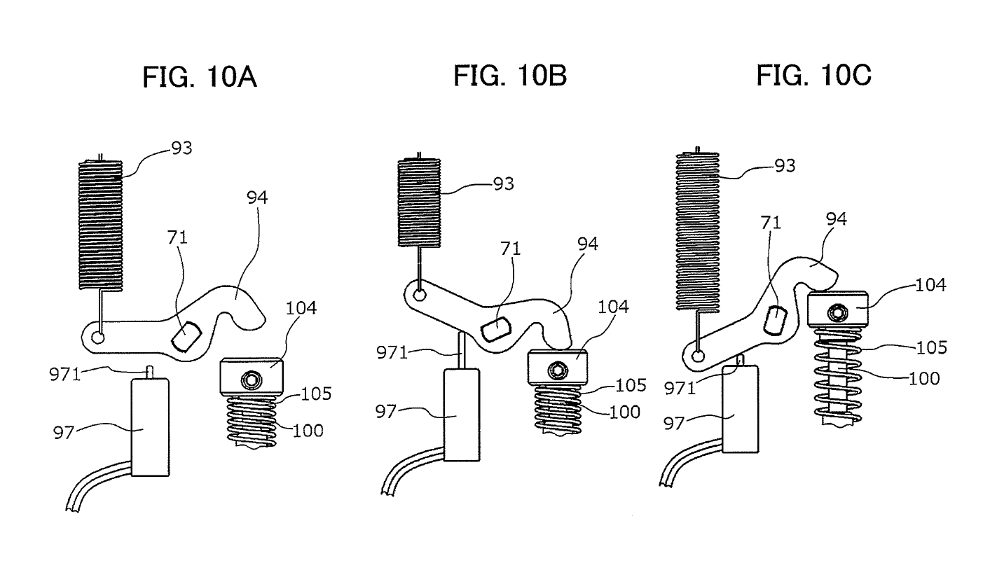

FIGS. 10A-10C show a variation of the present embodiment, in which an actuator 97 is employed instead of the throttle operation assisting coil 96 as another example of the throttle-operation assisting mechanism. The actuator 97 is configured of a solenoid, for example. The actuator 97 includes a pin 971 that is retracted when current is OFF, but can protrude when current is ON. In this case, the actuator 97 is fixed at a side opposite to the side at which the throttle-operation assisting coil 96 is provided with respect to the arm 94. Thus, the protruding pin 971 pushes up and pivotally moves the arm 94 in the direction to increase the throttle opening (clockwise in FIG. 10B). The movement of the arm 94 in FIGS. 10A and 10B is similar to the movement of the arm 94 in FIGS. 7A and 7B, respectively. Thus, the actuator 97 can perform controls similar to those of the above-described throttle-operation assisting coil 96.

Note that, in this variation, too, the torque exerted on the arm 94 by the throttle return spring 105 should be set to be larger than torque exerted on the arm 94 when the pin 971 pushes the arm 94. Hence, when the operator releases the throttle lever 17, a state shown in FIG. 10C can be obtained regardless of the state of the actuator 97, and the engine 40 becomes the idling state. Hence, if the actuator 97 is employed instead of the throttle operation assisting coil 96, the rotation speed of the engine 40 in the working state can be controlled rapidly, and switching between the idling state and the working state can be realized appropriately.

Incidentally, in the configuration of the depicted embodiment shown in FIGS. 7A-7C, the arm 94 is stopped (engaged) by the throttle-operation assisting coil 96 at a position to maximize the throttle opening. Hence, the throttle valve shaft 71 does not pivotally move further clockwise to go beyond this position (so as to increase the throttle opening). On the other hand, in the configuration of FIGS. 10A-10C, the actuator 97 does not restrict clockwise pivotal movement of the arm 94. However, because the right end portion of the arm 94 abuts on the arm abutting portion 104, in actual operations the throttle valve shaft 71 does not move pivotally further clockwise from the state shown in FIG. 10B.

If the actuator 97 is employed, no special structure is necessary to be provided on the arm 94 for performing the above-described movement, unlike the arm attracted portion 941 provided on the arm 94 that is necessary when the throttle-operation assisting coil 96 is employed. Further, if the throttle-operation assisting coil 96 is employed, the attraction force by the throttle-operation assisting coil 96 becomes stronger as a distance between the throttle-operation assisting coil 96 and arm attracted portion 941 is shorter, whereas the attraction force becomes weaker as this distance is longer. Thus, once the throttle-operation assisting coil 96 and arm attracted portion 941 are separated from each other, the attraction force thereafter becomes weaker, which may possibly slow down the velocity of the movement shown in FIGS. 7A and 7B in some cases. In contrast, in the configuration of FIGS. 10A-10C where the actuator 97 is employed, the arm 94 can be constantly pushed up by a stable force from the pin 971, thereby achieving a more stable control.

As the throttle-operation assisting mechanism of the present invention, other variations may also be available. For example, a throttle-operation assisting coil (just like the throttle-operation assisting coil 96) may be fixed to a side opposite to the throttle-operation assisting coil 96 with respect to the arm 94 (i.e., at the same side as the actuator 97 of the variation shown in FIGS. 10A-10C). A permanent magnet may be fixed to a portion of the arm 94 that confronts the throttle-operation assisting coil. In this case, the throttle-operation assisting coil is configured to generate a magnetic field that can repel the permanent magnet by repulsive force, so that movements similar to those of the actuator 97 can be obtained.

Still another configuration may also be available as the throttle-operation assisting mechanism, as long as the arm 94 (the throttle valve shaft 71) can be biased in the direction to increase the throttle opening against the movement of the wind governor 90, for example, by controlling ON and OFF of the current applied to the throttle-operation assisting mechanism in a particular rotation speed range. In this case, AC current generated in the engine 40 (generator coil) may be rectified and used as current for driving this throttle-operation assisting mechanism. Depending on types of the employed throttle-operation assisting mechanism, AC current can be used as it is, without rectification. Or, AC current generated in the engine 40 (generator coil) may be rectified and stored in a battery or the like, and the stored electric power can be used as the current for driving the throttle-operation assisting mechanism. Still alternatively, an external power supply independent of the engine 40 may be employed for driving the throttle-operation assisting mechanism. A power source for the throttle-operation assisting mechanism may be arbitrarily selected, as long as the above-described operations can be performed. Still alternatively, throttle-operation assisting mechanism that is not driven by electric current may also be employed. However, the above-described configuration of the embodiment is most preferable, because no special power supply for driving the throttle-operation assisting mechanism (throttle-operation assisting coil 96) is required, and a simplified structure can be realized.

Incidentally, if the throttle-operation assisting coil 96 is used as the throttle-operation assisting mechanism, it is conceivable that the arm 94 is applied with strong forces concurrently at different portions of the arm 94 in different directions, which may cause deformation of the arm 94. Thus, in order to suppress such deformation, preferably, the arm 94 is given a more rigid structure and is made by a material having higher rigidity, compared to those of the governor rod 92 etc. provided on the opposite end of the throttle valve shaft 71.

Further, in the above-described embodiment, the throttle-operation assisting mechanism (throttle-operation assisting coil 96) is provided at the same side of the throttle valve shaft 71 as the arm 94 and the throttle wire 100 in the carburetor 70 and at the opposite side from the governor rod 92 and the like. However, the arrangement of these elements is arbitrary, and can be set appropriately depending on configurations of a wind governor and a carburetor. However, it is preferable to distribute these elements at both sides of a throttle valve shaft in the carburetor, in order to realize a simplified structure and to ensure smooth operations.

In the depicted example, the brush cutter is used as an example of the engine-powered work tool of the present invention. However, the present invention can also be applicable to other types of portable engine-powered work tools provided with air-cooled engines.

While the invention has been described in detail with reference to the above-described embodiments thereof, it would be apparent to those skilled in the art that various changes and modifications may be made therein without departing from the scope of the invention.

What is claimed is:

1. An engine-powered work tool comprising:
an air-cooled engine including a crank shaft configured to rotate and a cooling fan fixed to the crank shaft and configured to rotate together with the crank shaft to generate cooling air;
an engine output controller configured to control an output of the engine, the engine output controller including a throttle valve shaft defining an axis and configured to make an angular rotation about the axis, the output of the engine being controlled based on the angular rotation of the throttle valve shaft;
a wind governor connected to the throttle valve shaft and including a governor plate configured to move upon receipt of the cooling air thereon, the wind governor being configured to control the angular rotation of the throttle valve shaft based on an amount of the cooling air received by the governor plate; and
a throttle-operation assisting mechanism configured to cause the throttle valve shaft to angularly rotate in a direction to increase the output of the engine within a prescribed rotation speed range, the operation by the throttle-operation assisting mechanism being predominant over the control by the wind governor within the prescribed rotation speed range.

2. The engine-powered work tool as claimed in claim 1, wherein the throttle-operation assisting mechanism causes the throttle valve shaft to forcibly angularly rotate to increase the output of the engine within the prescribed rotation speed range against the control over the throttle valve shaft by the wind governor.

3. The engine-powered work tool as claimed in claim 2, wherein the wind governor is configured to control the throttle valve shaft to angularly rotate to decrease the output of the engine within the prescribed rotation speed range,
wherein the throttle-operation assisting mechanism causes the throttle valve shaft to forcibly angularly rotate to increase the output of the engine within the prescribed rotation speed range against the control over the throttle valve shaft by the wind governor to decrease the output of the engine.

4. The engine-powered work tool as claimed in claim 1, wherein the throttle-operation assisting mechanism is configured to be electrically driven to cause angular rotation of the throttle valve shaft upon application of current.

5. The engine-powered work tool as claimed in claim 4, wherein the wind governor further comprises an arm fixed to the throttle valve shaft, the arm including a magnetic portion configured to be attracted to the throttle-operation assisting mechanism by electromagnetic force, and
wherein the throttle-operation assisting mechanism is configured to attract the magnetic portion of the arm to cause the angular rotation of the throttle valve shaft upon application of the current.

6. The engine-powered work tool as claimed in claim 4, wherein the wind governor further comprises an arm fixed to the throttle valve shaft, the arm including a permanent magnet, and
wherein the throttle-operation assisting mechanism is configured to generate a magnetic field to repel the permanent magnet of the arm by repulsive force to cause the angular rotation of the throttle valve shaft upon application of the current.

7. The engine-powered work tool as claimed in claim 4, wherein the wind governor further comprises an arm fixed to the throttle valve shaft, and
wherein the throttle-operation assisting mechanism comprises a pin configured to push the arm to cause the angular rotation of the throttle valve shaft upon application of the current.

8. The engine-powered work tool as claimed in claim 4, wherein the current applied to the throttle-operation assisting mechanism is generated by the rotation of the crank shaft.

9. The engine-powered work tool as claimed in claim 4, further comprising a control circuit configured to recognize the rotation speed of the crank shaft and control whether to apply the current to the throttle-operation assisting mechanism based on the rotation speed of the crank shaft.

10. The engine-powered work tool as claimed in claim 9, further comprising an ignition coil configured to generate spark current for igniting the engine, the control circuit being positioned adjacent to the ignition coil.

11. The engine-powered work tool as claimed in claim 1, wherein the engine output controller includes a main body through which the throttle valve shaft penetrates, the throttle valve shaft having one end and another end opposite to each other, the governor plate being fixed to the one end of the throttle valve shaft, and
wherein the wind governor further comprises a governor spring connected to the another end of the throttle valve shaft to apply a biasing force to the throttle valve shaft in the direction to increase the output of the engine.

12. The engine-powered work tool as claimed in claim 1, wherein the wind governor is configured to determine a designated rotation speed of the crank shaft of the engine operating under no load, and
wherein the prescribed rotation speed range is set to be equal to or lower than the designated rotation speed.

13. The engine-powered work tool as claimed in claim 1, further comprising:
an end tool configured to be driven in accordance with the rotation of the crank shaft; and
a supporting shaft having one end provided with the end tool and another end provided with the air-cooled engine, the engine output controller, the wind governor and the throttle-operation assisting mechanism.
